(19) United States
(12) Patent Application Publication
(10) Pub. No.: US 2009/0240539 A1
(43) Pub. Date: Sep. 24, 2009

(54) MACHINE LEARNING SYSTEM FOR A TASK BROKERAGE SYSTEM

(75) Inventors: Dean A. Slawson, Beijing (CN); Raman Chandrasekar, Seattle, WA (US); Vikram Dendi, Bellevue, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 12/053,259

(22) Filed: Mar. 21, 2008

(51) Int. Cl. G06F 15/18; G06N 3/12; G06F 17/30

(52) U.S. Cl. 705/7; 706/12; 706/13

(57) ABSTRACT

A machine learning system learns models to assist providers in processing documents of customers. Providers may use various productivity tools that use the learned models to assist in performing tasks on target documents of customers. The machine learning system may initially train models based on demographic information of customers and training data of the customers. To generate the models, the machine learning system collects the training data for the customers of each cluster and then trains a model for each cluster. The machine learning system uses the models to perform tasks on documents of customers. A provider can then modify the results of the task. The machine learning system can use those modifications to adjust the models.

### CROSS-REFERENCE TO RELATED APPLICATIONS

This application is related to U.S. patent application Ser. No. 12/026,523, entitled “Affordances Supporting Microwork on Documents,” and filed on Feb. 8, 2008, and U.S. patent application Ser. No. ______ (41826.8477US), entitled “Recommendation System for a Task Brokerage System,” and filed on Mar. 21, 2008, which are hereby incorporated by reference.

### BACKGROUND

Labor markets facilitate an efficient division of labor to perform various projects. Typically, a person who requires a project to be performed searches for and hires qualified persons to perform the project. However, the granularity at which a project may be practically divided into tasks that can then be performed by different persons (or more generally entities) has been relatively coarse. For example, the building of a house can be divided into coarse tasks such as building the foundation, framing the house, installing the roof, and so on. The division of a project into more fine-grained tasks has been limited by a variety of factors such as management overhead, skills availability, difficulty of efficiently matching buyers and sellers, issues surrounding confidentiality and trust, and so on. The limits may be especially problematic for knowledge workers (e.g., people who generate electronic documents such as scholarly articles, professional drawings, patent applications, and presentations). These knowledge workers, who are typically highly specialized, often need tasks to be performed that are outside their area of expertise. For example, a physics professor in China who is writing a scholarly article in English on the formation of black holes may not be particularly knowledgeable about English grammatical rules. To ensure that the article is free of grammatical errors, the professor needs a skilled editor to review the article. Similarly, the professor may not be familiar with drawing tools needed to make the figures of the article look professional. Unless the professor's university happens to have a skilled editor for the English language or a skilled draftsperson on staff in the physics department, it can be difficult for the professor to find the right persons to perform those tasks.

Some systems are available to help knowledge workers manage tasks. For example, a project management tool can help a manager in a company track a complex project such as generating a request for proposal or preparing a response to a request for proposal. If the knowledge workers to whom tasks are assigned are employees of the company, it can be fairly easy for the manager to assign the tasks of the project. It, however, becomes more difficult if the tasks need to be assigned to people outside the company. As another example, a workflow tool may allow a manager to specify the workflow sequence for a document. The workflow may specify that a certain junior writer is to generate the first draft, a certain senior writer is to revise and approve it, an editor is to review and edit it, a draftsperson is to generate professional drawings for it, a layout person is to format it, and so on. These tools, however, do not provide much assistance in helping a manager or knowledge worker identify who can perform a task (especially when the skill to perform the task is not readily available), how to describe the needed task, how much to pay for the task, what tasks are really needed, and so on.

A person who performs a task on many documents for many different people may use productivity tools to improve their efficiency and effectiveness. For example, a person who performs language translation (e.g., Japanese to English) may use an automated translator to generate an initial translation of a document. The translator might then manually review the translated document to correct any translation errors. Each translator may be able to improve the effectiveness of the automated translator by customizing the translation model (e.g., by adding mappings from kanji characters to possible English words and adding words to the translation dictionary). As another example, a person who performs speech-to-text translation may use an automated translator to generate an initial translation of a document and then edit the translation. The translator may train the automated translator by highlighting mistranslations and providing the correct translations (e.g., “once killed in the art” corrected to “one skilled in the art”). A difficulty with such an approach is that each person who performs a task can improve their effectiveness based only on their own experiences. In addition, a person who wants to start performing a task would need to start from a generic productivity tool and customize it over time based on their own experiences. Thus, people who currently use the productivity tool cannot effectively benefit from the experiences of others, and new people who want to start performing a task may be at such a competitive disadvantage that they simply decide not to compete.

### SUMMARY

A machine learning system is provided that uses machine learning techniques to learn models used by productivity tools based on experiences of providers who perform tasks on electronic documents for customers. In some embodiments, the machine learning system works in conjunction with a task brokerage system provided by a broker that helps customers who need tasks to be performed on documents to identify providers who can perform the requested tasks. The task brokerage system allows customers to publish their tasks and providers to discover the published tasks. The discovery process may match providers to customers based on criteria such as reputation, pricing, and availability.

The machine learning system learns models to assist providers in processing documents of customers. Providers may use various productivity tools that use the learned models to assist in performing tasks on target documents of customers. Each productivity tool may have a model, a mapping, a dictionary, and/or other list of parameters, generally referred to as a model, that can be customized to improve the effectiveness of the productivity tools. The machine learning system may initially train models based on demographic and other relevant information of customers and training data of the customers. The machine learning system may identify clusters of customers with similar demographic information using various clustering algorithms. The machine learning system may assume that customers with similar demographic information will likely benefit from similar models. To generate the models, the machine learning system collects the training data for the customers of each cluster and then trains a model for each cluster.

The machine learning system uses the models generated for the clusters to assist providers in performing tasks on target documents of customers. When a task is to be performed on a target document of a customer, the machine learning system identifies the cluster of that customer and uses a model for that cluster to assist in performing that task. A provider may then refine the result generated using the model to provide a more refined result. The machine learning system may adjust the model based on refinements to the result made by the provider to generate a refined result.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram that illustrates components of the machine learning system in some embodiments.

FIG. 2 is a block diagram illustrating a logical layout of a data structure for tracking information of the machine learning system.

FIG. 3 is a flow diagram that illustrates the processing of the generate models component of the machine learning system in some embodiments.

FIG. 4 is a flow diagram that illustrates the processing of the apply model component of the machine learning system in some embodiments.

FIG. 5 is a flow diagram that illustrates the processing of the adjust models component of the machine learning system in some embodiments.

FIG. 6 is a flow diagram that illustrates the processing of the combine models component of the machine learning system in some embodiments.

FIG. 7 is a flow diagram that illustrates the processing of the split models component of the machine learning system in some embodiments.

### DETAILED DESCRIPTION

A machine learning system is provided that uses machine learning techniques to learn models used by productivity tools based on experiences of providers who perform tasks on electronic documents for customers. In some embodiments, the machine learning system works in conjunction with a task brokerage system provided by a broker that helps customers who need tasks to be performed on documents to identify providers who can perform the requested tasks. The task brokerage system allows customers to publish their tasks and providers to discover the published tasks. The discovery process may match providers to customers based on criteria such as reputation, pricing, and availability.

A machine learning system is provided that learns models to assist providers in processing documents of customers. In some embodiments, the machine learning system works in conjunction with a task brokerage system as described in U.S. patent application Ser. No. 12/026,523. A task brokerage system provided by a broker (also referred to as a “microwork broker”) helps customers (also referred to as “microwork customers”) who need tasks (also referred to as “microtasks”) to be performed on documents to identify providers (also referred to as “microwork providers”) who can perform the requested tasks. The task brokerage system allows customers to publish their tasks and providers to discover the published tasks. The task brokerage system may also maintain reputations of the customers and providers who are “participants” in the brokering of tasks. The reputations may be derived from customer ratings of providers and provider ratings of customers. The discovery process may match providers to customers based on criteria such as reputation, pricing, and availability. The task brokerage system may provide facilities by which a customer can help ensure that a provider will preserve the confidentiality of the customer's information.

In some embodiments, providers may use various productivity tools to assist in performing tasks on target documents of customers. For example, a productivity tool may be a speech-to-text translator, a language translator (e.g., French to English), a document layout generator, a grammar checker, a drawing translator, and so on. Each of these productivity tools may have a model, a mapping, a dictionary, and/or a list of parameters, generally referred to as a model, that can be customized to improve the effectiveness of the productivity tools. For example, a speech-to-text translator may have a model representing the speaker's voice, a document layout generator may have a mapping of input formats to desired target formats (e.g., a table without borders to a table with borders), and a grammar checker may have a syntactic model. The machine learning system may learn a model based on initial training data. Many productivity tools provide a training mode in which training data can be collected and then used to generate a model. For example, a speech recognition productivity tool may ask a person to read a document and then train a model based on the corresponding acoustics of the speech. Productivity tools may use a variety of well-known learning techniques such as those based on Hidden Markov models, support vector machines, Bayesian networks, k-nearest neighbor algorithms, genetic programming, Monte Carlo methods, adaptive boosting algorithms, belief networks, decision trees, and so on.

In some embodiments, the machine learning system may initially train models based on demographic information of customers and training data of the customers. The demographic information may include the characteristics of each customer as maintained by the task brokerage system plus additional characteristics that may be useful in generating a model. For example, the characteristics of a customer that are maintained by the task brokerage system may include gender, occupation, age, home address, spoken language, and so on. The characteristics of a customer that may be useful in generating a model may include regional accent, style of writing (e.g., fiction, technical, or press release), field of specialization (e.g., medical or mathematics), nationality, and so on. The machine learning system may identify clusters of customers with similar demographic information using various clustering algorithms such as k-means clustering, hierarchical clustering, and so on. The machine learning system may assume that customers with similar demographic information will likely benefit from similar models. For example, a speech-to-text model that is customized to customers who speak a particular dialect or have a particular accent will result in a more effective translation than a more generic model. To generate the models, the machine learning system collects the training data for the customers of each cluster and then trains a model for each cluster.

The machine learning system uses the models generated for the clusters to assist providers in performing tasks on target documents of customers. When a provider requests a task to be performed on a target document of a customer, the machine learning system identifies the cluster of that customer and uses a model for that cluster to assist in performing that task. If the customer is a new customer that has not been associated with a cluster, then the machine learning system identifies a cluster for that customer. The machine learning system may use a distance metric to compare the demographic information of the new customer with the mean demographic information of the customers of each cluster. The machine learning system then associates the new customer with the cluster with the closest distance. The machine learning system may also use a collaborative filtering technique to identify a cluster for the customer. In some embodiments, the machine learning system may use multiple models or combine models when a customer has demographic information that is similar to the customers of different clusters. The machine learning system may use different weights for the different models based on similarity between the demographic information of the customer and the demographic information of the customers of the cluster or based on confidence that a cluster is the correct cluster for the customer.

In some embodiments, the machine learning system may adjust a model based on changes to the output or result of the productivity tool made by a provider. For example, a provider may use a speech-to-text translator to generate a result, which is an initial translation of a target document for a customer. The provider may then use a word processing program to correct or refine the translation. The corrected translation is a refined result that has been modified by refinements. For example, the provider may indicate that certain text represents a mistranslation or misrecognition of the corresponding speech. The machine learning system may also identify the refinements by comparing the result generated by the productivity tool with the refined result generated by the provider to identify the differences, which may be considered to be refinements. The machine learning system uses the refinements to adjust (retrain or relearn) the model. The adjusting of the model of a cluster can be an incremental adjustment or a complete relearning based on the initial training data and the refinements. The machine learning system adjusts the model for the cluster associated with the customer. The machine learning system may also factor in the confidence it has in a customer belonging to a cluster to weight the adjustments to the model. Thus, if the machine learning system is very confident that a user belongs to a cluster, then the machine learning system may give full weight to the refinements when adjusting the model. If the machine learning system is, however, not very confident that the user belongs to a cluster, then the machine learning system may give only partial weight to the refinements when adjusting the model for that cluster. The machine learning system may also factor in modifications made by customers to the refined results provided by the providers. These modifications can be useful in assessing not only the quality of the tasks performed by the providers, but also to adjust the models. For example, if a customer modifies many of the changes made by a provider, then the machine learning system may not want to adjust the model based on the provider's refinements. Also, if the customer makes additional refinements to the result, then the machine learning system may adjust the model based on the refinements of both the provider and the customer.

The machine learning system may adjust a model based on implicit or explicit input from a participant. Implicit input includes the refinements to a document, options selected by a user (e.g., from alternative word choices), and so on. Explicit input, in contrast, is provided directly by a participant. For example, a participant may indicate that a translation that selected a first option was wrong and that the second option would have been correct. In such a case, the machine learning system may weight this explicit input more than if the input was made implicitly. The machine learning system may not know whether the implied input was to correct something that was really wrong or simply to make a stylistic change and thus does not know how heavily to weight the refinements.

The machine learning system may use a client/server architecture to make productivity tools and models available to providers to perform tasks for customers. The models can be adjusted based on the refinements provided by the providers. The machine learning system may, however, not physically publish the models to the providers, but rather only use the models internally at the server. Because the providers are allowed to use the models only via the server, a provider cannot take a model and customize it for their own needs. Rather, the machine learning system encourages providers to contribute refinements that are used to improve the model that is shared by all providers. Thus, each provider can benefit from the models that have been adjusted based on the refinements of other providers. To prevent corruption of a model intentionally by an unscrupulous provider or unintentionally by an unskilled provider, the machine learning system may implement a rating system to rate a provider's history of adjustments to a model. The machine learning system can then prevent adjustments to the model based on refinements from providers with low ratings and may even prevent those providers from participating in the task brokerage system.

In some embodiments, the task brokerage system helps encourage customers to use the task brokerage system to contact providers, rather than contract a provider directly. This encouragement may take different forms. As described above, the task brokerage system may provide a machine learning system that provides automated performing of tasks that is better than and cheaper than the automated performing that can be provided by an individual provider. Also, the task brokerage system may automatically identify tasks for a customer, publish the identified tasks, identify providers to perform the tasks, and/or assign the tasks to the identified providers. In general, participants will be encouraged to use the task brokerage system because they can take advantage of its services that are improved and customized in part from the experiences gained in the brokering of many tasks for many consumers and providers.

In some embodiments, the machine learning system may combine models when models tend to be similar or split a model when the demographics indicates separate models may be more effective. To combine models, the machine learning system may calculate the distance between a model and every other model. If the distance between a model and another model is less than a combine threshold distance, then the machine learning system combines the associated clusters and models. The combined model for the new cluster may be generated by collecting the training data and refinements for all the customers in the clusters for the models that are to be combined and training a new model based on the training data and refinements. The new model is associated with a new cluster that includes all the customers of the two old clusters. To split models, the machine learning system may generate two sub-clusters of the customers of the cluster for the model. The machine learning system may train a model for each sub-cluster based on the training data and refinements for the customers in that sub-cluster. If the distance between the two models is greater than a split threshold distance, then the machine learning system considers the sub-clusters to be two new clusters, each represented by the corresponding new model.

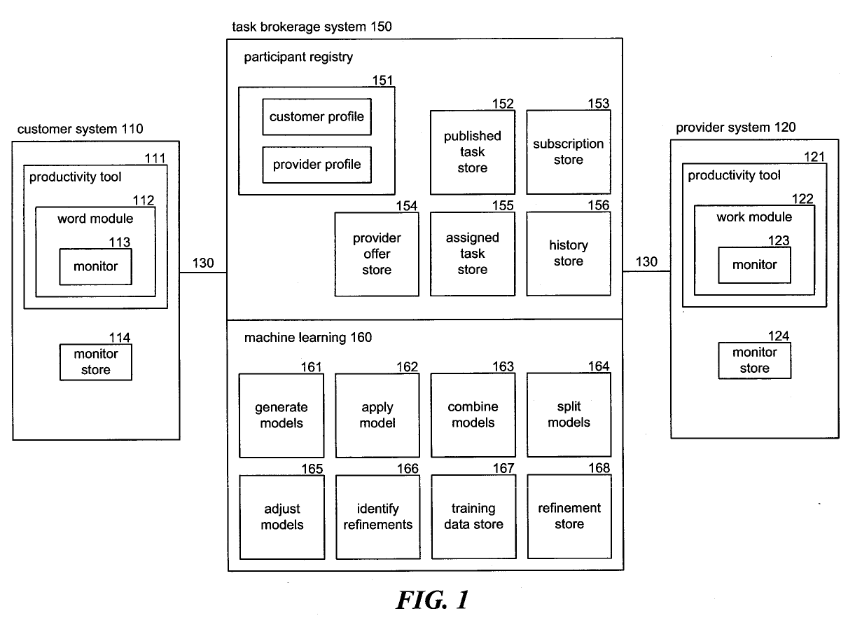

FIG. 1 is a block diagram that illustrates components of the machine learning system in some embodiments. The task brokerage system 150 may be connected to customer systems 110 and provider systems 120 via communication links 130. A customer system may include a productivity tool 111 (e.g., a word processing program or a drawing program) with an add-in work module 112 that provides customer-side functionality of the task brokerage system, which may assist a customer in publishing a task. The work module may also include a monitor component 113 that monitors the activity of the customer and stores information describing the activity in a monitor store 114. A provider system may also include a productivity tool 121 (e.g., a speech-to-text translator or a language translator) with an add-in work module 122 that provides provider-side functionality of the task brokerage system, which may assist a provider in discovering tasks. The work module may also include a monitor component 123 that monitors the activity of the provider and stores information describing the activity in a monitor store 124. The monitored activity may be used to identify the modifications to the result (e.g., refinements made by a provider), which are then provided to the machine learning system for adjusting a model.

The task brokerage system 150 may include a participant registry 151, a published task store 152, a subscription store 153, a provider offer store 154, an assigned task store 155, and a history store 156. The participant registry may contain customer and provider profile information, which includes characteristics of the participants. The published task store contains an entry describing each task that has been published by a customer. The subscription store contains an entry for subscriptions of providers to published tasks. The subscription information can be used to notify providers when tasks are published that match the criterion of their subscription (e.g., using a publisher/subscriber model). The provider offer store contains an entry for each offer of a provider to perform a published task. The assigned task store contains a mapping of published tasks to the provider who the customer and the provider agree is to perform the task of the customer. The history store contains information describing the performance and other information about each transaction in which a provider performs a task for a customer. The task brokerage system may also include a workflow component that allows a customer to specify a sequence of tasks to be performed on the task and coordinates the performing of the tasks of the workflow.

The task brokerage system includes a machine learning system 160 that supports performing of tasks that are model-based. The machine learning system includes a generate models component 161, an apply model component 162, a combine models component 163, a split models component 164, an adjust models component 165, an identify refinements component 166, a training data store 167, and a refinement store 168. The generate models component identifies clusters of customers based on demographic information and generates an initial model for each cluster based on the training data of the customers within the cluster. The apply model component inputs a target document and an indication of a customer, identifies a cluster associated with that customer, and applies the model for that cluster to the target document to generate a result. The combine models component identifies models of clusters within a combine threshold distance and generates a combined model based on the training data and refinements of the customers of the clusters. The split models component identifies models that would more appropriately be split into two models and generates new models for the model being split. The adjust models component inputs refinements to results generated by a model and adjusts the model accordingly. The identify refinements component identifies refinements to results either by receiving refinements from providers and/or comparing results to refined results to identify differences. The training data store contains the training data of the customers. The refinement store contains the refinements made by providers to the results of target documents.

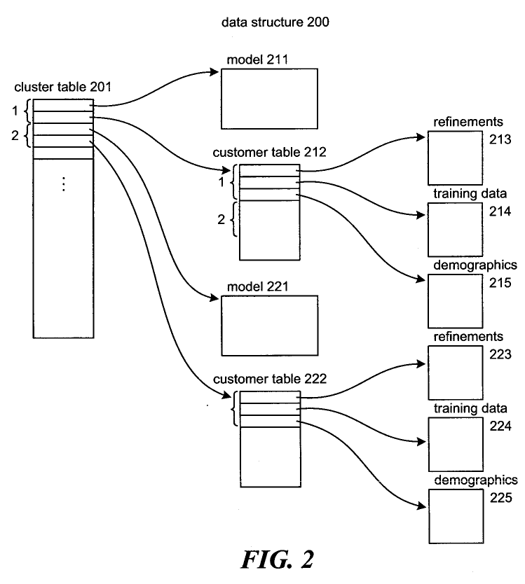

FIG. 2 is a block diagram illustrating a logical layout of a data structure for tracking information of the machine learning system. The data structure 200 includes a cluster table 201 with an entry for each cluster of customers. Each entry of the cluster table contains a reference to a model 211 or 221 for the cluster and a customer table 212 or 222. The model contains the data of the model for the productivity tool. In some embodiments, the machine learning system may include a separate cluster table for each productivity tool for which models are learned. The customer table contains an entry for each customer associated with the cluster. Each entry of a customer table contains a reference to refinements 213 or 223, training data 214 or 224, and demographic information 215 or 225 of the customer. The refinements are a collection of the refinements received from providers for that customer's target documents. The training data contains the training data associated with the customer. The demographic information contains characteristics of the customer that are relevant to the model of the productivity tool.

The computing device on which the machine learning system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the machine learning system, which means a computer-readable medium that contains the instructions. In addition, the instructions, data structures, and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the machine learning system may be implemented in and used with various operating environments that include personal computers, server computers, hand-held or laptop devices, multiprocessor systems, microprocessor-based systems, programmable consumer electronics, digital cameras, network PCs, minicomputers, mainframe computers, computing environments that include any of the above systems or devices, and so on.

The machine learning system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments. The data structures illustrated include logical representations of data. The actual organization of the data structures may include hash tables, indexes, trees, and so on.

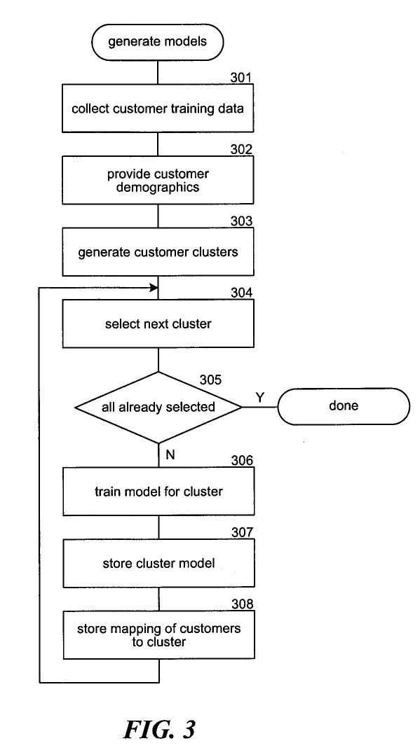

FIG. 3 is a flow diagram that illustrates the processing of the generate models component of the machine learning system in some embodiments. The component identifies clusters based on demographic information of customers and generates a model for each cluster based on the training data of the customers of that cluster. In block 301, the component provides the customer training data. The customer training data may be collected from the customers in a training phase. For example, if the task to be performed for a customer is speech-to-text translation, then the machine learning system may collect sample readings from the customers during the training phase. In block 302, the component retrieves demographic information of the customers. The demographic information may be derived from the customer profile maintained by the task brokerage system and augmented with additional demographic information needed for the training of the model. In block 303, the component generates the clusters of customers who have similar demographic information. In blocks 304-308, the component loops generating a model for each cluster. In block 304, the component selects the next cluster. In decision block 305, if all the clusters have already been selected, then the component completes, else the component continues at block 306. In block 306, the component trains the model for the selected cluster using the training data of the customers of the cluster. In block 307, the component stores the model for the selected cluster. In block 308, the component stores a mapping of customers to the cluster and loops to block 304 to select the next cluster.

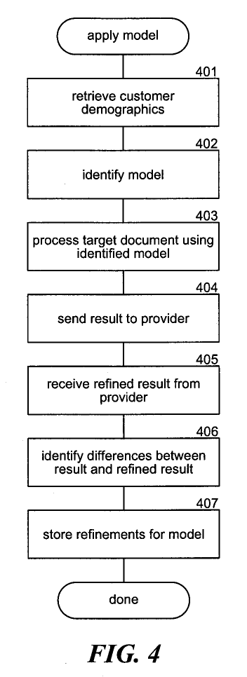

FIG. 4 is a flow diagram that illustrates the processing of the apply model component of the machine learning system in some embodiments. The component is passed a target document of a customer and performs the task on the target document using the model for the cluster associated with that customer. In block 401, the component retrieves the demographic information of the customer from the data structure 200 and the participant registry 151. In block 402, the component identifies the cluster and the model for that cluster. If the customer is new, then the component identifies the cluster to which the customer should belong. In block 403, the component processes the target document using the identified model. In block 404, the component sends the result of the processing to the provider. In block 405, the component receives a refined result from the provider. In block 406, the component identifies the differences between the result and the refined result as the refinements. In block 407, the component stores the refinements for the model in the data structure 200 and completes.

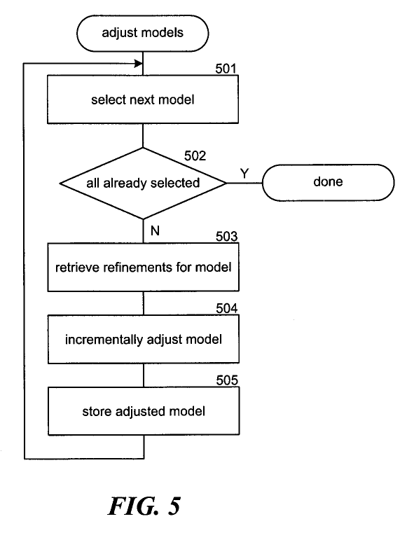

FIG. 5 is a flow diagram that illustrates the processing of the adjust models component of the machine learning system in some embodiments. The component loops selecting the model of each cluster and adjusting the model based on refinements made by providers to results of the customers associated with the cluster. In block 501, the component selects the model of the next cluster. In decision block 502, if all the models have already been selected, then the component completes, else the component continues at block 503. In block 503, the component retrieves the refinements for the customers of the cluster. In block 504, the component incrementally adjusts the model based on the retrieved refinements. In block 505, the component stores the adjusted model and then loops to block 501 to select the model of the next cluster.

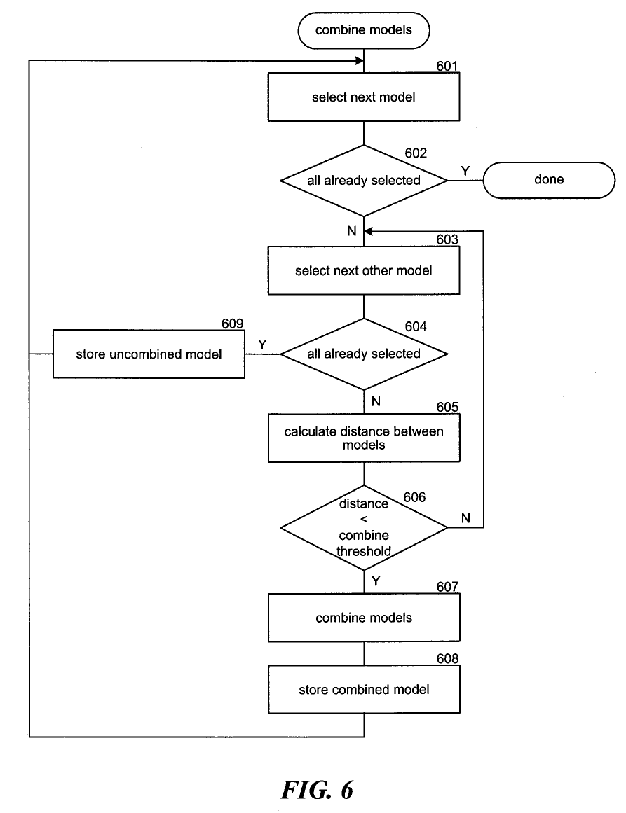

FIG. 6 is a flow diagram that illustrates the processing of the combine models component of the machine learning system in some embodiments. The component loops selecting each pair of models and combining them when the distance between the models is less than a combine threshold distance. In block 601, the component selects the model of a cluster to determine whether it should be combined with another model. In block 602, if all the models have already been selected, then the component completes, else the component continues at block 603. In blocks 603-606, the component loops selecting the model of each other cluster and determining whether the distance between the selected models is less than the combine threshold distance. In block 603, the component selects the model of the next other cluster. In decision block 604, if all the models of the other clusters have already been selected, then the model is not to be combined and the component stores the uncombined model in block 609 and loops to block 601 to select the model of the next cluster. Otherwise, the component continues at block 605. In block 605, the component calculates the distance between the selected models. In decision block 606, if the distance is less than a combine threshold distance, then the component continues at block 607, else the component loops to block 603 to select the next other model. In block 607, the component combines the models. The component may combine the models by training a new model based on the combined training data and refinements of the customers of the clusters for each selected model. In block 608, the component stores a combined model and loops to block 601 to select the next model. In some embodiments, the component may attempt to further combine a combined model with other models when the distance between the models is less than the combined threshold distance. Thus, the component may effectively combine two, three, four, or any number of models that are within the combine threshold distance. To achieve this combining, the component may be repeatedly invoked until no models are combined during an invocation.

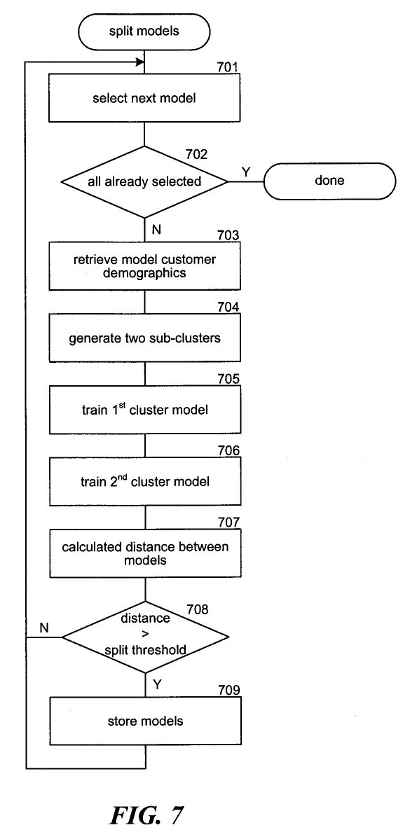

FIG. 7 is a flow diagram that illustrates the processing of the split models component of the machine learning system in some embodiments. The component selects each model, generates two sub-clusters for the customers associated with that model, generates a model for each sub-cluster, and determines whether the models are different enough to represent two different models. In block 701, the component selects the model of the next cluster. In decision block 702, if all the models have already been selected, then the component completes, else the component continues at block 703. In block 703, the component retrieves the customer demographic information for the model. In block 704, the component generates two sub-clusters for the customers based on the demographic information. In block 705, the component trains a model for the first sub-cluster. In block 706, the component trains a model for the second sub-cluster. In block 707, the component calculates the distance between the models. In decision block 708, if the distance between the models is greater than a split threshold distance, then the selected model is to be split into the trained models and the component continues at block 709, else the component loops to block 701 to select the model of the next cluster. In block 709, the component stores the model for each sub-cluster as the model for a new cluster, removes the cluster for the model being split, and then loops to block 701 to select the next model. In some embodiments, the component may attempt to further split each model of a sub-cluster. Thus, a model may be split into any number of models. To further split an already split model, the component may be implemented to recursively invoke itself to process each split model. Alternatively, the component may be invoked repeatedly until an invocation results in no model being split.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. For example, the machine learning system may allow a provider to specify its customers (a group of customers) and have a model trained for those customers or models trained for clusters of those customers. Thus, the machine learning system may support provider-specific models or models that are specific to groups of providers (e.g., translators that are employees of a translation service company). The machine learning system may also provide recommendations for providers to a customer based on analysis of performance of the providers on target documents of customers with demographic information similar to that of the customer. Accordingly, the invention is not limited except as by the appended claims.

I/We claim:

1. A method in a computing device for learning models for processing documents in a task brokerage system, the method comprising:
providing demographic information for customers;
providing training data for the customers;
generating models based on the provided training data and demographic information of the customers;
receiving a target document of a customer;
selecting a generated model based on demographic information of the customer;
applying the selected model to the target document to generate a result;
determining refinements to the result made by a provider when generating a refined result; and
adjusting the selected model based on the refinements to the result made by the provider
wherein refinements made by providers to results of applying a selected model to a target document are used to adjust the selected model.

2. The method of claim 1 wherein the generating of the models includes:
identifying clusters of customers based on their demographic information; and
for each cluster, training a model based on the training data of the customers within the cluster.

3. The method of claim 1 including combining models when a distance between models is less than a combine threshold distance.

4. The method of claim 3 wherein models are combined by training a combined model using training data and refinements of results of target documents of customers within the clusters of the models to be combined.

5. The method of claim 1 including splitting a model for a cluster when models generated for sub-clusters of customers of the cluster have a distance that is greater than a split threshold distance.

6. The method of claim 5 wherein the splitting includes:
identifying sub-clusters of customers of the cluster; and
for each sub-cluster, generating a model using training data and refinements of results of target documents of customers of the sub-cluster.

7. The method of claim 1 wherein the processing of documents includes language translation of the target document of a first language into the result in a second language.

8. The method of claim 1 wherein the generated model is further selected based on the task and related information.

9. The method of claim 1 wherein the refinements are determined by collecting corrections the provider makes to the result.

10. The method of claim 1 wherein the refinements are determined by identifying differences between the result and the refined result.

11. The method of claim 1 wherein the applying of the selected model to the target document is performed at a server and the result is sent to the provider wherein the provider cannot download the model.

12. The method of claim 1 wherein the selecting of the generated model is further based on input from a provider.

13. The method of claim 1 wherein the models are learned based on training data of customers of a group of providers.

14. A computing device for providing models for processing documents of customers in a task brokerage system, comprising:
a model store containing models for processing documents, the models being learned based on training data and demographic information of customers of the task brokerage system;
a component that selects a model for a customer and applies the selected model to a target document of a customer to generate a result;
a component that identifies refinements to the result made by a provider when generating a refined result for the result; and
a component that adjusts the selected model based on the refinements to the result made by the provider to the result.

15. The computing device of claim 14 wherein the models are learned by identifying clusters of customers based on their demographic information and, for each cluster, training a model based on the training data of the customers within the cluster.

16. The computing device of claim 14 including a component that combines models when a distance between models is less than a combine threshold distance.

17. The computing device of claim 14 including a component that splits a model for a cluster when models generated for sub-clusters of customers of the cluster have a distance that is greater than a split threshold distance.

18. The computing device of claim 14 including a component that inputs a selection of customers from a provider and generates a model for the provider based on training data of the selected customers.

19. The computing device of claim 14 including a component that recommends a provider to a customer based on analysis of performance of the providers on target documents of customers with similar demographic information to the customer.

20. A computer-readable storage medium encoded with computer-executable instructions for learning models for processing documents in a task brokerage system, by a method comprising:
providing demographic information for customers;
providing training data for the customers;
generating models by identifying clusters of customers based on their demographic information and, for each cluster, training a model based on the training data of the customers within the cluster;
for each of a plurality of target documents of customers, receiving the target document of a customer;
selecting a generated model based on demographics of the customer;
applying the selected model to the target document to generate a result;
providing the result to a provider for refinement; and
identifying refinements to the result made by the provider; and
adjusting the models of the clusters based on the identified refinements made by the providers to the results of target documents of customers of the cluster so that the adjusted models can subsequently be applied to target documents of customers.
